(19) United States
(12) Patent Application Publication
(10) Pub. No.: US 2018/0215966 A1
(43) Pub. Date: Aug. 2, 2018

(54) ADDITIVE COMPOSITION SUITABLE FOR USE IN A STRUCTURAL ADHESIVE

(71) Applicant: ARKEMA FRANCE, Colombes (FR)

(72) Inventors: Christian Bret, Bordeaux (FR); Olivier FRADIN, PESSAC (FR); Mathieu ROUX, CERONS (FR); Emilie VAIQUE, PEUJARD (FR); Nicolas VALLOIR, GRADIGNAN (FR); Raber INOUBLI, PAU (FR)

(21) Appl. No.: 15/747,961

(22) PCT Filed: Jul. 8, 2016
(86) PCT No.: PCT/FR2016/051748

§ 371 Date: Jan. 26, 2018

(30) Foreign Application Priority Data
Jul. 28, 2015 (FR) 15 57197

(51) Int. Cl. C09J 11/08; C09J 4/06; C09J 9/00; C09J 5/00

(52) U.S. Cl. CPC C09J 11/08; C09J 4/06; C09J 9/00; C09J 2201/622; C09J 2451/00; C09J 2453/00; C09J 2433/00; C09J 5/00

(57) ABSTRACT

The present invention relates to an additive composition which can be used in particular in a structural adhesive.

According to the invention, characteristically, it comprises:
at least one styrene-free block copolymer formed of at least two blocks and in particular of at least three blocks; and
a plurality of particles of the core/shell type comprising a first polymer of elastomer type.

The present invention relates to an additive composition which can be used in a structural adhesive. “Structural” adhesives are composed of two constituents, stored separately, generally in tubes. The first of the constituents contains the monomer or the mixture of monomers capable of forming a solid body by polymerization, whereas the second constituent contains the catalyst which will bring about the polymerization. Polymerization is brought about by mixing the two constituents.

Generally, mixtures of monomers of methacrylate type are used.

The document WO 2012/131185 describes a composition which can be used in structural adhesives, in particular structural adhesives of methacrylate type.

This document describes a polymeric system comprising styrene-free block copolymers formed of at least two blocks and advantageously of at least three blocks. This system is dissolved in a methacrylate matrix which can comprise styrene-containing elements, such as styrene/butadiene rubber, a styrene/butadiene/styrene copolymer and/or a styrene/butadiene/methyl methacrylate copolymer. The block polymers which can be used are, for example, PMMA/PBU/PMMA block copolymers or PMMA/PBA/PMMA block copolymers (PMMA meaning polymethyl methacrylate, PBU meaning polybutadiene and PBA meaning polybutyl acrylate).

The abovementioned document indicates that the choice of styrene-free block copolymers makes it possible to obtain an elongation at break, measured according to the standard ISO 527-1A, which is three times higher than that obtained with the same composition but not containing the abovementioned block copolymers. After polymerization of the adhesive, the latter furthermore withstands temperatures of more than 200° C., which makes it possible to paint the assembly obtained by bonding with the adhesive.

The applicant company has noticed that, surprisingly, it is possible in particular to further increase this elongation at break and/or to improve other properties of the assemblies of adhesively bonded parts.

Thus, the present invention provides an additive composition usable in particular in a structural adhesive, which characteristically, according to the invention, comprises:
at least one styrene-free block copolymer formed of at least two blocks and in particular of at least three blocks;
and a plurality of particles of the core/shell type comprising an elastomer material.

This is because the applicant company has found that the addition of solid particles of the core/shell type as mentioned above makes it possible to further increase the elongation at break. The applicant company has thus demonstrated the existence of a synergy between the abovementioned block copolymers and the abovementioned solid particles of the core/shell type.

Furthermore, it has found that, unexpectedly and surprisingly, the addition of solid particles as mentioned above may also make it possible to increase the thixotropic index of the composition. This property is highly valuable in the manufacture of a structural adhesive. The abovementioned particles make it possible to reduce the amount of rheological additive(s), such as fumed silicas, polymer waxes and clays of bentonite type, which are normally used, indeed even to replace these additives. This is because these rheological additives are liable to reduce the adhesion provided by the structural adhesive and their use is thus to be limited.

Furthermore, the applicant company has also found that the addition of particles as mentioned above may enhance the cold impact and/or the hot impact.

Preferably, the solid particles of core/shell type do not dissolve in the abovementioned block copolymer(s) or in a monomer of acrylic or methacrylic type, in particular in methyl methacrylate. According to a first embodiment, the block copolymer comprises at least one block A chosen from:
PMMA;
PMMA, at least a portion of the CH₃ and/or OCH₃ groups of the PMMA block of which are replaced by a functional atom or group chosen from a H atom or a carboxyl, NH₂ or 1,2-epoxypropyl (CH₂CHOCH₂) group;
PMMA copolymers obtained by copolymerization of methyl methacrylate with at least one monomer chosen from acrylic acid, alkylated derivatives of acrylic acid, in particular methacrylic acid, ethyl acrylate, butyl acrylate, hexyl 2-ethylacrylate, hydroxyethyl acrylate, hexyl 2-ethylmethacrylate, amides of acrylic acid, amides of methacrylic acid, in particular dimethylacrylamide, ethyl 2-methoxyacrylate, ethyl 2-methoxymethacrylate, 2-aminoethyl acrylates, 2-aminoethyl methacrylates, quaternary amines of ethyl 2-methoxyacrylate, of ethyl 2-methoxymethacrylate, 2-aminoethyl acrylates and 2-aminoethyl methacrylates, polyethylene glycol acrylates, polyethylene glycol methacrylates, water-soluble monomers, water-soluble monomers comprising a vinyl group, in particular N-vinylpyrrolidone.

The applicant company has demonstrated that the presence of a PMMA block, optionally functionalized as mentioned above, or of a PMMA copolymer, preferably comprising at least 50% of PMMA, makes it possible to improve at least one of the parameters chosen from the elongation at break, the thixotropic index, the cold impact and the postcuring impact.

The other block or blocks of the block copolymer are not limited according to the invention.

According to another embodiment, which can be combined with the preceding embodiment, said block copolymer comprises at least one block B of a polymer which exhibits a glass transition temperature Tg substantially equal to or less than 0° C. and in particular substantially equal to or less than −40° C.

Thus, as nonlimiting examples, the block B can be chosen from:
PBA (polybutyl acrylate);
PBA, at least a portion of the CH₃ and/or OCH₃ groups of the PBA block of which are replaced by a functional atom or group chosen from a H atom or a carboxyl, NH₂ or 1,2-epoxypropyl (CH₂CHOCH₂) group;
PBA copolymers obtained by copolymerization of butyl acrylate with at least one monomer chosen from acrylic acid, alkylated derivatives of acrylic acid, in particular methacrylic acid, ethyl acrylate, butyl acrylate, hexyl 2-ethylacrylate, hydroxyethyl acrylate, hexyl 2-ethylmethacrylate, amides of acrylic acid, amides of methacrylic acid, in particular dimethylacrylamide, ethyl 2-methoxyacrylate, ethyl 2-methoxymethacrylate, 2-aminoethyl acrylates, 2-aminoethyl methacrylates, quaternary amines of ethyl 2-methoxyacrylate, of ethyl 2-methoxymethacrylate, 2-aminoethyl acrylates and 2-aminoethyl methacrylates, polyethylene glycol acrylates, polyethylene glycol methacrylates, water-soluble monomers, water-soluble monomers comprising a vinyl group, in particular N-vinylpyrrolidone.

The block copolymer can comprise a block A as defined with reference to the first embodiment and a block B as defined in the abovementioned examples.

According to a specific embodiment, said block copolymer comprises at least one block A and one block B, in that said block A is chosen from:
PMMA;
PMMA, at least a portion of the CH₃ and/or OCH₃ groups of the PMMA block of which are replaced by a functional atom or group chosen from a H atom or a carboxyl, NH₂ or 1,2-epoxypropyl (CH₂CHOCH₂) group;
PMMA copolymers obtained by copolymerization of methyl methacrylate with at least one monomer chosen from acrylic acid, alkylated derivatives of acrylic acid, in particular methacrylic acid, ethyl acrylate, butyl acrylate, hexyl 2-ethylacrylate, hydroxyethyl acrylate, hexyl 2-ethylmethacrylate, amides of acrylic acid, amides of methacrylic acid, in particular dimethylacrylamide, ethyl 2-methoxyacrylate, ethyl 2-methoxymethacrylate, 2-aminoethyl acrylates, 2-aminoethyl methacrylates, quaternary amines of ethyl 2-methoxyacrylate, of ethyl 2-methoxymethacrylate, 2-aminoethyl acrylates and 2-aminoethyl methacrylates, polyethylene glycol acrylates, polyethylene glycol methacrylates, water-soluble monomers, water-soluble monomers comprising a vinyl group, in particular N-vinylpyrrolidone;
   and said block B is chosen from:
PBA;
PBA, at least a portion of the CH₃ and/or OCH₃ groups of the PBA block of which are replaced by a functional atom or group chosen from a H atom or a carboxyl, NH₂ or 1,2-epoxypropyl (CH₂CHOCH₂) group;
PBA copolymers obtained by copolymerization of butyl acrylate with at least one monomer chosen from acrylic acid, alkylated derivatives of acrylic acid, in particular methacrylic acid, ethyl acrylate, butyl acrylate, hexyl 2-ethylacrylate, hydroxyethyl acrylate, hexyl 2-ethylmethacrylate, amides of acrylic acid, amides of methacrylic acid, in particular dimethylacrylamide, ethyl 2-methoxyacrylate, ethyl 2-methoxymethacrylate, 2-aminoethyl acrylates, 2-aminoethyl methacrylates, quaternary amines of ethyl 2-methoxyacrylate, of ethyl 2-methoxymethacrylate, 2-aminoethyl acrylates, 2-aminoethyl methacrylates, polyethylene glycol acrylates, polyethylene glycol methacrylates, water-soluble monomers, water-soluble monomers comprising a vinyl group, in particular N-vinylpyrrolidone.

The block copolymer can be a polymethyl methacrylate-block-polybutyl acrylate-block-polymethyl methacrylate copolymer.

The plurality of particles can comprise particles which comprise a first polymer of elastomer type, the glass transition temperature of which is substantially equal to or less than 0° C. and in particular substantially equal to or less than −40° C. This first polymer can in particular be present in the core. It can also be present in the shell or in the core and the shell of the particle.

Such particles make it possible to increase the elongation at break, the cold impact and/or the postcuring impact.

This first polymer can be chosen from acrylic polymers, polybutadiene, in particular crosslinked polybutadiene, styrene and butadiene copolymers, polybutyl acrylate, polysiloxanes, in particular poly(dimethylsiloxane), and mixtures of at least two of these polymers/copolymers.

According to a specific embodiment, said first polymer is present in particular in said core, and said shell of said particles comprises a second polymer, the glass transition temperature of which is substantially equal to or greater than 30° C. This second polymer can also be present in the core. The first polymer can also be present in said shell.

According to a specific embodiment, which can be combined with any one of the abovementioned embodiments, said second polymer exhibits a glass transition temperature Tg which is substantially greater than 30° C. and substantially equal to or less than 150° C., in particular substantially greater than 60° C. and more particularly substantially greater than 80° C., advantageously substantially greater than 90° C. and more advantageously substantially greater than 100° C.

According to a specific embodiment of the second polymer, the latter comprises double bonds and/or vinyl units. This specific embodiment of the second polymer can be combined with any embodiment of the first polymer.

Thus, the second polymer can be chosen from acrylic copolymers and methacrylic copolymers and in particular from acrylic copolymers containing at least 70% by weight of monomers chosen from C₁-C₁₂-alkyl acrylates, methacrylic copolymers containing at least 70% by weight of monomers chosen from C₁-C₁₂-alkyl methacrylates, in particular from acrylic or methacrylate copolymers respectively comprising at least 80% by weight of monomers of C₁-C₄-alkyl acrylate type or 80% by weight of monomers of C₁-C₈-alkyl methacrylate type. The first polymer can in particular be optionally crosslinked polybutadiene.

By way of examples, said acrylic monomers are chosen from methyl acrylate, ethyl acrylate, butyl acrylate and mixtures of at least two of said monomers, and said methacrylic monomers are chosen from methyl methacrylate, ethyl methacrylate, butyl methacrylate and mixtures of at least two of said monomers. In this case, the first polymer can in particular be optionally crosslinked polybutadiene.

Advantageously, the second polymer comprises at least 50% by weight of monomer units originating from methyl methacrylate. In this case, said first polymer can be chosen from acrylic polymers, polybutadiene, in particular crosslinked polybutadiene, styrene and butadiene copolymers, polybutyl acrylate, polysiloxanes, in particular poly(dimethylsiloxane), and mixtures of at least two of these polymers/copolymers. The first polymer can more particularly be optionally crosslinked polybutadiene.

According to a specific embodiment, the solid particles comprise a core containing polybutadiene and a shell containing PMMA.

The composition according to the invention can also comprise at least one monomer of acrylic type and/or at least one monomer of methacrylic type.

According to a specific embodiment, the composition comprises a PMMA-block-PBA-block-PMMA block copolymer and particles of core/shell type, the core of which contains a first polymer of elastomer type, the glass transition temperature of which is substantially equal to or less than 0° C. and in particular substantially equal to or less than −40° C., and the shell of which contains a second polymer, the glass transition temperature of which is substantially equal to or greater than 30° C., in particular substantially greater than 30° C. and substantially equal to or less than 150° C., in particular substantially greater than 60° C. and more particularly substantially greater than 80° C., advantageously substantially greater than 90° C. and more advantageously substantially greater than 100° C.; it being possible for the first polymer also to be present in said shell and it being possible for said second polymer also to be present in said core.

The present invention also relates to a structural adhesive kit comprising a first composition containing:

at least one monomer of acrylic or methacrylic type;

an additive composition according to the invention;

optionally physical and/or chemical rheological additives;

optionally at least one adhesion additive; and

at least one amine chosen from aliphatic, heterocyclic and aromatic amines and in particular from secondary and tertiary amines.

Mention may be made, as examples of rheological additives, of fumed silica, calcium carbonate, talc, clays, in particular bentonite, and polyamide wax.

Mention may be made, as examples of adhesion additive, of: compounds of the silyl type, phosphate compounds and sulfonic acids.

The kit can also comprise a second composition capable of polymerizing said monomer when it is mixed with said first composition, said second composition comprising radical compounds, in particular peroxides and/or compounds of the azonitrile type.

According to a specific embodiment, the first composition contains:
an amount of said monomer which is substantially equal to or greater than 5% by weight and substantially equal to or less than 60% by weight of said first composition, in particular an amount of methacrylate which is substantially equal to or greater than 15% by weight and substantially equal to or less than 60% by weight of said first composition;
an amount of said additive according to the invention which is substantially equal to or greater than 5% by weight and substantially equal to or less than 87.5% by weight of said first composition;
an amount of rheological additive(s) which is substantially equal to or greater than 0% by weight and substantially equal to or less than 5% by weight of said first composition;
an amount of adhesion additive(s) which is substantially equal to or greater than 1% by weight and substantially equal to or less than 10% by weight of said first composition, in particular substantially equal to 5%;
an amount of amine(s) which is substantially equal to or greater than 0.5% by weight and substantially equal to or less than 5% by weight of said first composition.

The additive composition according to the invention can be used in the manufacture of a structural additive which can be used for caulking, the adhesive bonding of metal parts or the adhesive bonding of parts made of glass, polystyrene, ABS, polyester, polycarbonate, aluminum, steel, stainless steel, galvanized steel and/or PMMA, in particular.

### Definitions

The term “polymer” encompasses homopolymers and copolymers.

The term “copolymer” encompasses block copolymers and random copolymers.

The term “polymer of elastomer type” denotes any polymer or mixture of polymers, the glass transition temperature of which is less than 20° C.

The acronym “PMMA” denotes polymethyl methacrylate.

The acronym “PBA” denotes polybutyl acrylate.

The terms “glass transition temperature” (Tg) denote the value obtained by DTA (Differential Thermal Analysis).

The thixotropic index is defined as being the ratio of the viscosity measured at a velocity v1 (expressed in revolutions per minute) to the viscosity measured at a velocity equal to 10 times v1. In particular, the term thixotropic index can be equal to the following ratio: viscosity measured at 2 rev/min to viscosity measured at 20 rev/min. The higher the thixotropic index, the more the composition studied becomes fluid with stirring or as a result of the increase in a shear stress which is applied to it.

The term “vinyl unit” denotes the following unit: CH₂αCH—.

The term “acrylic polymer” denotes any polymer comprising the following unit:

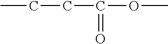

The term “methacrylic polymer” denotes any polymer comprising the following unit:

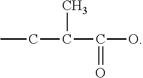

The cold impact is measured in the following way: two parts made of aluminum alloy of 6060 and/or 6061 type are assembled with overlapping over a surface area of 650 mm² by means of a layer of adhesive to be tested exhibiting a calibrated thickness of 500 μm. Eighteen hours after having produced the abovementioned assembly, the latter is placed at a temperature of −10° C. for 2 hours. Immediately after it has been removed from the device holding the assembly at the abovementioned temperature, the assembly is positioned on a vice. The assembly is then struck with a weight of 1.5 kg dropped from a height of 1 meter. The number of drops until the assembly breaks is defined as being the cold impact.

The postcuring impact is measured in the following way: two parts made of aluminum alloy of 6060 and/or 6061 type are assembled with overlapping over a surface area of 650 mm² by means of a layer of the adhesive to be tested exhibiting a calibrated thickness of 500 μm. Eighteen hours after having produced the abovementioned assembly, the latter is placed at a temperature of +200° C. for 30 minutes. Twelve hours after it has been removed from the device holding the assembly at the abovementioned temperature and thus return to the ambient temperature of 23° C., the assembly is positioned on a vice. The assembly is then struck with a weight of 1.5 kg dropped from a height of 1 meter. The number of drops until the assembly breaks is defined as being the postcuring impact.

The terms “monomer of acrylic type” denote, within the meaning of the present invention, any ester of acrylic acid including a carbon-carbon double bond and capable of polymerizing.

The terms “monomer of methacrylic type” denote any ester of methacrylic acid. It can in particular be methyl methacrylate.

### EXAMPLES

The block copolymers used are PMMA-block-PBA-block-PMMA (polymethyl methacrylate-block-polybutyl acrylate-block-polymethyl methacrylate) block copolymers.

The solid particles are particles comprising a core made of polybutadiene and a shell made of PMMA. They form a powder of particles having a measured mean diameter of 250 μm (D50, measured by dynamic light scattering using a ZetaSizer® device). The unit size of the particle is 170 nm (measured by dynamic light scattering using a ZetaSizer® device).

### Examples of Compositions

TABLE I

| | Composition A | | |
|---|---|---|---|
| Component | % by weight | Composition B | Composition C |
| Block copolymer | 9 | 0 | 12 |
| Core/shell solid | 0 | 19 | 19 |
| particles | | | |
| Mixtures of monomers | 41 | 41 | 41 |
| of methacrylate type | | | |
| Additives | 5 | 5 | 5 |

Three composition examples are combined in Table I. Composition A contains only the abovementioned block copolymer. Composition B contains only the solid particles. Composition C, which corresponds to a composition according to the invention, contains both the copolymer and the solid particles and makes it possible to show the synergy between these two elements.

### Properties

The elongation at break was measured according to the standard ISO 527-1A.

The thixotropic index was measured using a device of Brookfield type with an Elipath T-D spindle. The viscosities measured in mPa·s for the determination of the thixotropic index are those at 2 rev/min and 20 rev/min.

The cold impact and the postcuring impact are measured according to the abovementioned methods.

The result obtained for the three compositions of Table I are combined in Table II below.

TABLE II

| Characteristic | Composition A | Composition B | Composition C |
|---|---|---|---|
| Thixotropic index | 3 | 3.5 | 5 |
| Cold impact | 1 | 1 | 3 |
| Postcuring impact | 1 | 1 | 3 |
| Elongation | 60% | 160% | 180% |

In the light of the results of Table II, it is found that the presence of the solid particles makes it possible to considerably increase the thixotropic index, the cold impact, the hot impact and the elongation at break. It is thus found that there exists a synergy between the solid particles and the block copolymers.

1. An additive composition suitable for a structural adhesive, comprising:
at least one styrene-free block copolymer formed of at least two blocks; and
a plurality of particles of core/shell type comprising a first polymer of elastomer type which exhibits a glass transition temperature equal to or less than 0° C., the shell of said particles comprising a second polymer, the glass transition temperature of which is equal to or greater than 30° C.

2. The composition as claimed in claim 1, wherein said block copolymer comprises at least one block A chosen from:
polymethyl methacrylate (PMMA);
PMMA, at least a portion of the CH₃ and/or OCH₃ groups of the PMMA block of which are replaced by a functional atom or group chosen from a H atom or a carboxyl, NH₂ or 1,2-epoxypropyl (CH₂CHOCH₂) group; and
PMMA copolymers obtained by copolymerization of methyl methacrylate with at least one monomer chosen from acrylic acid, alkylated derivatives of acrylic acid, ethyl acrylate, butyl acrylate, hexyl 2-ethylacrylate, hydroxyethyl acrylate, hexyl 2-ethylmethacrylate, amides of acrylic acid, amides of methacrylic acid, ethyl 2-methoxyacrylate, ethyl 2-methoxymethacrylate, 2-aminoethyl acrylates, 2-aminoethyl methacrylates, quaternary amines of ethyl 2-methoxyacrylate, of ethyl 2-methoxymethacrylate, 2-aminoethyl acrylates and 2-aminoethyl methacrylates, polyethylene glycol acrylates, polyethylene glycol methacrylates, water-soluble monomers, water-soluble monomers comprising a vinyl group.

3. The composition as claimed in claim 1, wherein said block copolymer comprises at least one block B of a polymer which exhibits a glass transition temperature Tg equal to or less than 0° C.

4. The additive composition as claimed in claim 1, wherein said block copolymer comprises a block B which is chosen from:
polybutyl acrylate (PBA);
PBA, at least a portion of the CH₃ and/or OCH₃ groups of the PBA block of which are replaced by a functional atom or group chosen from a H atom or a carboxyl, NH₂ or 1,2-epoxypropyl (CH₂CHOCH₂) group; and
PBA copolymers obtained by copolymerization of butyl acrylate with at least one monomer chosen from acrylic acid, alkylated derivatives of acrylic acid, ethyl acrylate, butyl acrylate, hexyl 2-ethylacrylate, hydroxyethyl acrylate, hexyl 2-ethylmethacrylate, amides of acrylic acid, amides of methacrylic acid, ethyl 2-methoxyacrylate, ethyl 2-methoxymethacrylate, 2-aminoethyl acrylates, 2-aminoethyl methacrylates, quaternary amines of ethyl 2-methoxyacrylate, of ethyl 2-methoxymethacrylate, 2-aminoethyl acrylates and 2-aminoethyl methacrylates, polyethylene glycol acrylates, polyethylene glycol methacrylates, water-soluble monomers, water-soluble monomers comprising a vinyl group.

5. The composition as claimed in claim 1, wherein said block copolymer comprises at least one block A and one block B, wherein said block A is chosen from:
PMMA;
PMMA, at least a portion of the CH₃ and/or OCH₃ groups of the PMMA block of which are replaced by a functional atom or group chosen from a H atom or a carboxyl, NH₂ or 1,2-epoxypropyl (CH₂CHOCH₂) group; and
PMMA copolymers obtained by copolymerization of methyl methacrylate with at least one monomer chosen from acrylic acid, alkylated derivatives of acrylic acid, ethyl acrylate, butyl acrylate, hexyl 2-ethylacrylate, hydroxyethyl acrylate, hexyl 2-ethylmethacrylate, amides of acrylic acid, amides of methacrylic acid, ethyl 2-methoxyacrylate, ethyl 2-methoxymethacrylate, 2-aminoethyl acrylates, 2-aminoethyl methacrylates, quaternary amines of ethyl 2-methoxyacrylate, of ethyl 2-methoxymethacrylate, 2-aminoethyl acrylates and 2-aminoethyl methacrylates, polyethylene glycol acrylates, polyethylene glycol methacrylates, water-soluble monomers, water-soluble monomers comprising a vinyl group; and
wherein said block B is chosen from:
PBA;
PBA, at least a portion of the CH₃ and/or OCH₃ groups of the PBA block of which are replaced by a functional atom or group chosen from a H atom or a carboxyl, NH₂ or 1,2-epoxypropyl (CH₂CHOCH₂) group; and
PBA copolymers obtained by copolymerization of butyl acrylate with at least one monomer chosen from acrylic acid, alkylated derivatives of acrylic acid, ethyl acrylate, butyl acrylate, hexyl 2-ethylacrylate, hydroxyethyl acrylate, hexyl 2-ethylmethacrylate, amides of acrylic acid, amides of methacrylic acid, ethyl 2-methoxyacrylate, ethyl 2-methoxymethacrylate, 2-aminoethyl acrylates, 2-aminoethyl methacrylates, quaternary amines of ethyl 2-methoxyacrylate, of ethyl 2-methoxymethacrylate, 2-aminoethyl acrylates, 2-aminoethyl methacrylates, polyethylene glycol acrylates, polyethylene glycol methacrylates, water-soluble monomers, water-soluble monomers comprising a vinyl group.

6. The composition as claimed in claim 1, wherein said block copolymer is a polymethyl methacrylate-block-polybutyl acrylate-block-polymethyl methacrylate copolymer.

7. The composition as claimed in claim 1, wherein said first polymer is chosen from acrylic polymers, polybutadiene, styrene and butadiene copolymers, polybutyl acrylate, polysiloxanes, and mixtures of at least two of these polymers/copolymers.

8. The composition as claimed in claim 1, wherein said first polymer is present in said core.

9. The composition as claimed in claim 1, wherein said second polymer exhibits a glass transition temperature Tg which is greater than 30° C. and equal to or less than 150° C.

10. The composition as claimed in claim 1, wherein said second polymer comprises double bonds and/or vinyl units.

11. The composition as claimed in claim 10, wherein said second polymer is chosen from acrylic copolymers and methacrylic copolymers.

12. The composition as claimed in claim 11, wherein said second polymer comprises at least 50% by weight of monomer units originating from methyl methacrylate.

13. The composition as claimed in claim 1, wherein the solid particles comprise a core comprising polybutadiene and a shell comprising PMMA.

14. A structural adhesive kit comprising a first composition comprising:
at least one monomer of acrylic or methacrylic type;
an additive composition as claimed in claim 1;
optionally physical and/or chemical rheological additives;
optionally at least one adhesion additive;
at least one amine chosen from aliphatic, heterocyclic and aromatic amines.

15. The kit as claimed in claim 14, further comprising a second composition capable of polymerizing said monomer when it is mixed with said first composition and wherein said second composition comprises radical compounds.

16. The kit as claimed in claim 14, wherein said first composition comprises:
an amount of said monomer which is equal to or greater than 5% by weight and equal to or less than 60% by weight of said first composition;
an amount of said additive which is equal to or greater than 5% by weight and equal to or less than 87.5% by weight of said first composition;
an amount of rheological additive(s) which is equal to or greater than 0% by weight and equal to or less than 5% by weight of said first composition;
an amount of adhesion additive(s) which is equal to or greater than 1% by weight and equal to or less than 10% by weight of said first composition; and
an amount of amine(s) which is equal to or greater than 0.5% by weight and equal to or less than 5% by weight of said first composition.

17. A method of preparing the additive composition as claimed in claim 1, comprising combining the at least one styrene-free block copolymer and the plurality of particles of core/shell type.

18. A method of preparing an adhesive composition comprising combining the additive composition as claimed in claim 1, at least one monomer of acrylic or methacrylic type, and at least one amine chosen from aliphatic, heterocyclic and aromatic amines.

19. A structural adhesive prepared by a process comprising combining:
(1) a first composition comprising the additive composition as claimed in claim 1, at least one monomer of acrylic or methacrylic type, and at least one amine chosen from aliphatic, heterocyclic and aromatic amines; and
(2) a second composition comprising at least one radical compound and capable of polymerizing the monomer in the first composition.

20. A method of bonding parts comprising metal, glass, polystyrene, ABS, polyester, polycarbonate or PMMA, comprising applying the structural adhesive as claimed in claim 19 to the parts, wherein the monomer in the first composition is polymerized.
